(19) United States
(12) Patent Application Publication
(10) Pub. No.: US 2013/0293343 A1
(43) Pub. Date: Nov. 7, 2013

(54) DEVICE COMBINING A THERMAL FUSE AND A RESISTOR

(71) Applicants: Zhonghou Xu, Xiamen (CN); Yousheng Xu, Xiamen (CN); Xuanhui Zhu, Xiamen (CN)

(72) Inventors: Zhonghou Xu, Xiamen (CN); Yousheng Xu, Xiamen (CN); Xuanhui Zhu, Xiamen (CN)

(73) Assignees: XIAMEN SET ELECTRONICS CO., LTD., Xiamen, Fujian (CN); Zhonghou Xu, Xiamen, Fujian (CN)

(21) Appl. No.: 13/977,672

(22) PCT Filed: Dec. 28, 2011
(86) PCT No.: PCT/CN2011/084826

§ 371 Date: Jun. 28, 2013

(30) Foreign Application Priority Data
Dec. 31, 2010 (CN) 201020697438.7

(51) Int. Cl. H01C 13/00; H01C 3/20

(52) U.S. Cl. CPC H01C 13/00; H01C 3/20
USPC 338/269

(57) ABSTRACT

A device combining a thermal fuse and a resistor has a solid ceramic base of the wirewound resistor is changed to be hollow, a thermal fuse is disposed inside the ceramic base, the ceramic tube is the housing of the thermal fuse, one lead wire of the thermal fuse is passing through the end cap of one end of the wirewound resistor, the other end of the thermal fuse is extended out of the end cap of the other end of the wirewound resistor, the end cap of the wirewound resistor is extended out with a lead wire, then the whole product is encapsulated by epoxy resin. The device can serve as a basic unit, which is directly assembled to an existing high-frequency charger, it can take the place of the existing simple wirewound resistor or the wirewound resistor with a thermal fuse external contacted.

### FIELD OF THE INVENTION

The present invention relates to a resistor against over-current and over-heat, the device is a quick response structure with a resistor and a thermal fuse integration, the size is similar to a same power wirewound resistor, carbon-film resistor or a metal-film resistor, it's applied to over-heat resistor of the power supply of the household electric appliance, IT communication equipment or lighting equipment, it can be also be served as a heating element with over-heat protection.

The present invention further relates to a thermal fuse with heating function, it can be applied in blockage protection of the motor of the power tool or electrical fan; when the motor is blocked, with the current, the increasing rate of the temperature of the thermal fuse to cut off is much larger than that of the temperature of the coil of the motor, assuring that the motor will not be over-heat and blocked before the cut-off of the thermal fuse, it can be used to against over-heat of the motor.

### BACKGROUND OF THE INVENTION

With the widely application of the microelectrical equipment, especially the mobile communication equipment, charging device of a battery is the necessity of the mobile equipment. A high-frequency circuit is usually applied to design and construct a charger. For convenient to carry and the self-adaptation the AC100V-240V mains voltage, the safety performance of the charger is important. A current-limiting resistor against over-current and over-heat is the key component to the safety of the high-frequency circuit. The present invention is provided to meet the demanding with the safety performance of reliability and quick response.

Although the wirewound resistor also has over-current melt function, the resistor wire is applied with high melting point alloy and the alloy wire of the wirewound resistor will be melt to realize fuse function only if over 20 times of rated current flows. However, in actual application, when the load is abnormal, the current of the wirewound resistor is often unable to reach to the melt current, the melt performance of the wirewound resistor can not be present, the temperature of the wirewound resistor reaches to 300˜500° C., being a seriously danger to the charger. So that people applies with a thermal fuse external contacted in series and placed inside a ceramic box, when the thermal fuse senses that the temperature of the wirewound resistor reaches to the rating temperature of the thermal fuse, the thermal fuse is melt to cut off the circuit. However, it occupies two areas in the PCB and it needs 4 bonding pads.

In another hand, according to safety consideration, the micro-heating elements, such as fragrance device or liquid electric mat, are applied with a thermal fuse against over-heat. Existing assembly method is to connect a resistor and a thermal fuse in series then assemble above both inside a ceramic box, the box is filled with solidifiable insulation material. But the size of the product is too large, heat may lose too much, making energy waste.

In addition, the current of the blocked motor of power tool or electrical fan is six times of normal working current, the motor is heating fast, so it needs a thermal fuse to cut off the current to prevent over-heat and fire, but not to decrease the operation temperature of the thermal fuse to increase the agility. However, mild overload or voltage pulsation happens when the motor works, but the thermal fuse is unexpected to cut off. So trouble happens when setting the temperature of the thermal fuse.

An integration combining a thermal fuse and a resistor of new, small size, integrative structural and fast installation is provided, this structure may solve above three problems.

### SUMMARY OF THE INVENTION The present invention is provided with a resistor applied to the input of a high-frequency charger, and it adopts an alloy wire as the resistor, which has the resistor function and the melt protection function in high current. A thermal fuse is disposed inside the base of the wirewound resistor; the thermal fuse is connected to the resistor in series in the circuit. When the wirewound resistor heats to the rated temperature, the thermal fuse is melt to assure over-heat protection function.

The present invention relates to a wirewound resistor with a thermal fuse built-in, in which the solid ceramic base of the wirewound resistor is changed to be hollow, a thermal fuse is disposed inside the ceramic base, the ceramic tube is severed as the housing of the thermal fuse, when one lead wire of the thermal fuse is passing through the end cap of one end of the wirewound resistor, the thermal fuse and the wirewound resistor are connected in serious tightly, and the other lead wire of the thermal fuse is extended out of the end cap of the other end of the wirewound resistor, the end cap of the wirewound resistor with an opening is extended out with a lead wire, then the whole product is encapsulated by epoxy resin.

The present invention of a wirewound resistor with a built-in thermal fuse can be severed as a basic unit to be assembled directly to the existing high-frequency charger, the wirewound resistor with a built-in thermal fuse can take the place of the existing simple wirewound resistor or the wirewound resistor with a thermal fuse external contacted, realizing triple functions of normal resistor function, melt protection function in high current, over-heat protection when overloaded.

The resistor value of the wirewound resistor with above structure is set in 0.5Ω, the temperature of the coupling thermal fuse is 150° C. used in a motor of a power tool, take a thermal fuse with rated current 2 A for example, when the normal working current is 0.5 A, the temperature of the thermal fuse rises about 5° C. due to the resistor. But when the motor is blocked, the current reaches to 3 A, the heat of the resistor makes the temperature of the thermal fuse rising rapidly, the thermal fuse is cut off before the motor coil is damaged. According to above structure, replace the wirewound resistor to a carbon-film resistor or a metal-film resistor, the resistor value is increased greatly, this structure can be used as a micro-heater, fix it into a ceramic tube to sever as a heater of a fragrance device or liquid electric mat, the heater can be placed in the diffusion staff of perfume or other liquid, so that the thermal power of the heater can be absorbed by the perfume or other liquid. Existing technology is applied with a ceramic structure, one side of which is disposed with a hole to fix the diffusion staff while the other side is disposed with a cavity, the cavity is assembled with a heating resistor and a thermal fuse and encapsulated by solidifiable insulation material. Comparing above two, basic on same diffusion rate of the perfume, the power of the existing technology of the heater is about 2.2 W, the power of the heater of the present invention is about 1 W, so that the heating temperature of the resistor is decreased, the stability of the resistor value of the resistor is improved greatly and the diffusion rate of the perfume is more stable, the influence from the environmental temperature is decreased. If the power of a fragrance device decreases 1 W, 9 kW power can be saved every year. If there are 50 millions heaters of fragrance device or liquid electric mat working in the world, 45000 kW power can be saved, carbon emission decreased greatly.

### BRIEF DESCRIPTION OF THE DRAWINGS

FIG. 1 illustrates the circuit diagram of the first embodiment;

FIG. 2A illustrates the structure of the thermal fuse of the first embodiment;

FIG. 2B illustrates the structure of the thermal fuse of the second embodiment;

FIG. 3A illustrates the structure of the wirewound resistor of the first embodiment;

FIG. 3B illustrates the structure of the wirewound resistor of the second embodiment;

FIG. 4A illustrates the structure of the structure of the application product of the first embodiment;

FIG. 4B illustrates the structure of the structure of the first embodiment without the lead wire in the common port of the wirewound resistor and the thermal fuse;

FIG. 5 illustrates the structure of third embodiment applied in a fragrance device;

FIG. 6 illustrates the structure of fourth embodiment of a resistor with an organism temperature sensing built-in thermal fuse;

FIG. 7 illustrates the principle diagram of the fourth embodiment of a resistor with an organism temperature sensing built-in thermal fuse.

### DETAILED DESCRIPTION OF THE EMBODIMENTS

### The First Embodiment

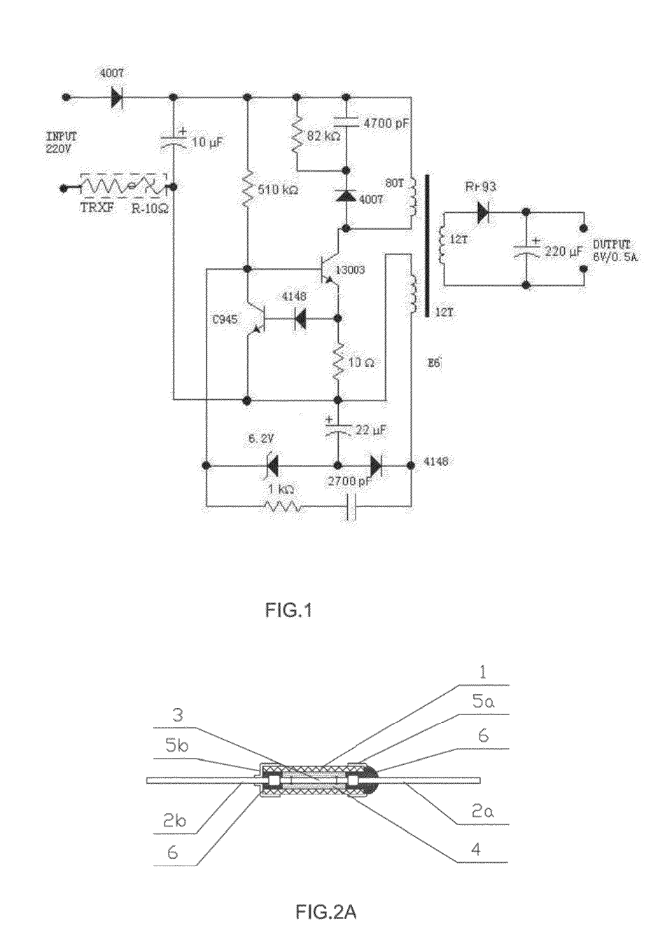

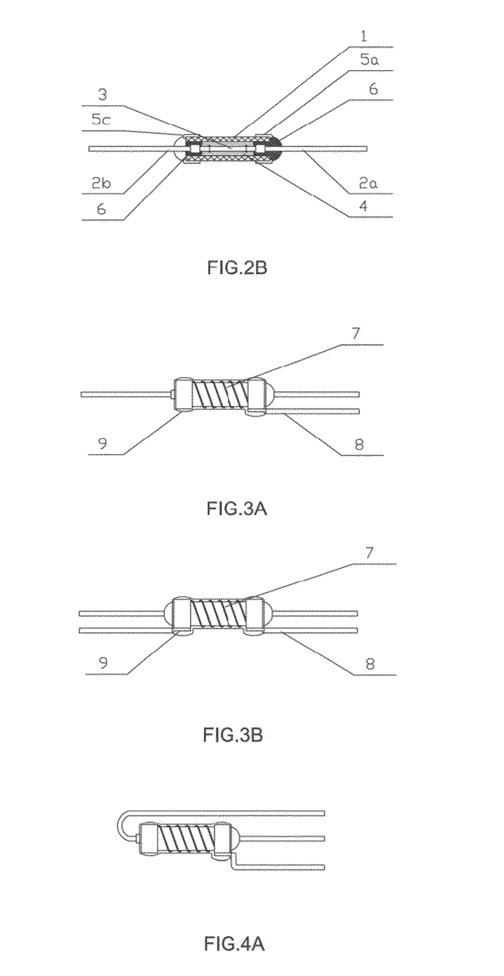

The first embodiment will be further described with the FIG. 1, FIG. 2A and FIG. 3A. thereinto, the object of the embodiment is to describe the preferred embodiment of the present invention, but not limited.

FIG. 1 is the circuit of a switched power supply charger of a mobilephone or an MP3, and the circuit is applied with the device combining a thermal fuse and a resistor of the present invention; in FIG. 2A, the lead wires 2b, 2a of the thermal fuse is welded with low-melting point alloy wire 3. A fluxing agent 4 is disposed around the alloy wire 3 to improve the alloy wire to contract to two sides and cut off when molten, the thermal fuse, fluxing agent 4 and the alloy wire 3 form a whole under the normal temperature to be placed inside the ceramic tube, then two ends of the ceramic tube are encapsulated by epoxy resin 6 to be made into an entire thermal fuse.

As figured in FIG. 2A, when above thermal fuse is formed, put the metal caps 5a, 5b to lock to the two ends of the ceramic tube 1 of the thermal fuse, forming a tight integration. The centre of the metal cap 5b is extended out with a liplike edge, which is connected to the lead wire 2b of the thermal fuse; when the metal cap 5b is welded to the alloy wire of the wirewound resistor, the thermal fuse and the wirewound resistor are connected in series. The hole in the centre of the metal cap 5a is large enough for the lead wire 2a of the thermal fuse to pass through, a clearance is formed between the hole and the lead wire 2a, the creepage distance of the lead wire 2a and the metal cap 5a increases to a safe distance after the clearance is encapsulated by epoxy resin 6.

When two ends of the ceramic tube 1 of the thermal fuse are sleeved with the metal cap 5a, 5b, basic body of the wirewound resistor is shaped. Wire is wound in the resistor alloy wire 7 in the basic body, two ends of the resistor alloy wire 7 are welded to the metal cap 5a, 5b. then a lead wire 8 is welded to the metal cap 5a as the output of the wirewound resistor. The whole product is encapsulated by epoxy resin 9 finally. In this way, a wirewound resistor with a built-in thermal fuse is made, as figured in FIG. 3A.

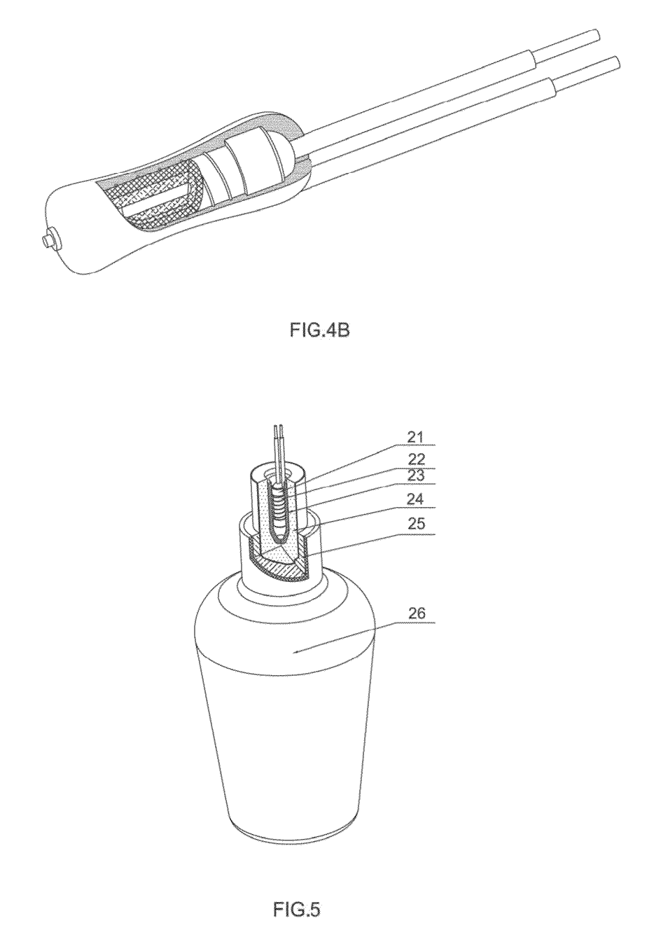

FIG. 4 and FIG. 5 are the actual assemblies of the present invention. FIG. 4B is circuit structure that the thermal fuse and the wirewound resistor are connected in series with one end input and the other end output. FIG. 1 is the circuit of the present invention applied in a high-frequency charger, in which the wirewound resistor is in over-heat protection mode.

### The Second Embodiment

As figured in FIG. 2B and FIG. 3B, different from the first embodiment, the thermal fuse and the wirewound resistor are connected in parallel in a circuit, the wirewound resistor is wound to the ceramic housing of the thermal fuse. The lead wires of the metal caps (5a, 5c) in two ends of the wirewound resistor are not connected to the lead wires of the thermal fuse.

### The Third Embodiment

The table below is the protection result data of the wirewound resistor with a thermal fuse in the first embodiment. In a high-frequency power supply, it often applies a 10Ω/2 W wirewound resistor and a 221° C. thermal fuse against over-heat, the comparison of cut-off speed of the external contact type and the built-in type (the first embodiment) is as below. If single wirewound resistor is not added, high surface temperature for a long time is a hidden danger in the current in the table.

TABLE 1

| | | | | Surface | |
|---|---|---|---|---|---|
| | | Surface | Cut-off Time of | Temperature of | Cut-off Time of |
| | | Temperature of the | the External | the Built-in | the Built-in |
| | Test | External Contact | Contact Type | Type | Type Thermal |
| Number | Current A | Type Resistor ° C. | Thermal Fuse S | Resistor ° C. | Fuse S |
| 1 | 0.5 | 142 | Not Cut-off in | 145 | Not Cut-off in |
| | | | 600 s | | 600 s |
| 2 | 0.5 | 139 | Not Cut-off in | 142 | Not Cut-off in |
| | | | 601 s | | 601 s |
| 3 | 0.5 | 146 | Not Cut-off in | 148 | Not Cut-off in |
| | | | 602 s | | 602 s |
| 4 | 0.5 | 143 | Not Cut-off in | 145 | Not Cut-off in |
| | | | 603 s | | 603 s |
| 5 | 0.6 | 175 | 36 s | 176 | 18 s |
| 6 | 0.6 | 174 | 37 s | 177 | 19 s |
| 7 | 0.6 | 178 | 36 s | 176 | 18 s |
| 8 | 0.6 | 176 | 39 s | 178 | 18 s |
| 9 | 0.7 | 189 | 26 s | 190 | 8 s |
| 10 | 0.7 | 187 | 27 s | 192 | 7 s |
| 11 | 0.7 | 190 | 23 s | 193 | 8 s |
| 12 | 0.7 | 188 | 24 s | 189 | 7 s |
| 13 | 0.8 | 211 | 14 s | 215 | 1.2 s |
| 14 | 0.8 | 209 | 16 s | 212 | 1.0 s |
| 15 | 1 | 234 | 8 s | 238 | 0.2 s |
| 16 | 1 | 232 | 9 s | 242 | 0.2 s |

### The Fourth Embodiment

The structure of the fourth embodiment is the same as that of the first embodiment, with different resistor value and temperature from the first embodiment, the heating of the wirewound resistor accelerates the cut-off of the thermal fuse, it is mainly applied in the motor against over-heat. The resistor value of the wirewound resistor with above structure is set in 0.5Ω, the temperature of the coupling thermal fuse is 150° C. used in a motor of a power tool, take a thermal fuse with rated current 2 A for example, when the normal working current is 0.5 A, the temperature of the thermal fuse rises about 5° C. due to the resistor. But when the motor is blocked, the current reaches to 3 A, the heat of the resistor makes the temperature of the thermal fuse rising rapidly, the thermal fuse is cut off before the motor coil is damaged, pretending the motor coil form burning and improving the recycle value. It can be further described with the data below:

TABLE 2

| | | | Surface | | |
|---|---|---|---|---|---|
| | | Temperature of | Temperature of the | | |
| | Fusing | the Simulation | Wirewound | Cut-off Time of | Withstand |
| Number | Current A | Coil ° C. | Resistor ° C. | the TCO | Voltage |
| 1 | 0.5 | 62.8 | 74.9 | Not Cut-off in a | |
| | | | | Long Time | |
| 2 | 0.5 | 63.1 | 75.4 | Not Cut-off in a | |
| | | | | Long Time | |
| 3 | 0.5 | 62.9 | 75.8 | Not Cut-off in a | |
| | | | | Long Time | |
| 4 | 1 | 63.6 | 90.2 | Not Cut-off in a | |
| | | | | Long Time | |
| 5 | 1 | 63.8 | 90.8 | Not Cut-off in a | |
| | | | | Long Time | |
| 6 | 1 | 63.9 | 91.4 | Not Cut-off in a | |
| | | | | Long Time | |
| 7 | 1.5 | 64.5 | 107.4 | Not Cut-off in a | Not |
| | | | | Long Time | Breakdown in |
| | | | | | 500 V |
| 8 | 1.5 | 64.6 | 106.9 | Not Cut-off in a | Not |
| | | | | Long Time | Breakdown in |
| | | | | | 500 V |
| 9 | 1.5 | 64.7 | 107.8 | Not Cut-off in a | Not |
| | | | | Long Time | Breakdown in |
| | | | | | 500 V |
| 10 | 2 | 65.4 | 132.5 | 58 | Not |
| | | | | | Breakdown in |
| | | | | | 500 V |
| 11 | 2 | 65.5 | 132.1 | 52 | Not |
| | | | | | Breakdown in |
| | | | | | 500 V |
| 12 | 2.5 | 66.7 | 162.7 | 7 | Not |
| | | | | | Breakdown in |
| | | | | | 500 V |
| 13 | 2.5 | 66.4 | 160.2 | 6 | Not |
| | | | | | Breakdown in |
| | | | | | 500 V |
| 14 | 3 | 69.4 | 167.5 | 3 | Not |
| | | | | | Breakdown in |
| | | | | | 500 V |

### The Fifth Embodiment

The structure of the fifth embodiment is the same as that of the first embodiment, as figured in FIG. 4B, replace the wirewound resistor to a carbon-film resistor or a metal-film resistor 22, the resistor value is increased to thousands of ohms, this structure can be used as a micro-heater 21 (as figured in FIG. 5); the micro-heater 21 of built-in thermal fuse is made into a fragrance device, which comprising a micro-heater 21, a housing 23, a diffusion staff 24, a sealing ring 25, a perfume bottle 26. put the housing 23 with a built-in micro-heater 21 into the diffusion staff 24, the diffusion staff 24 is passed through the sealing ring 25 and inserted into the perfume bottle 26, forming a fragrance device.

TABLE 3
Test Report of the Comparison of the Heating of the Resistor

| | | | | | | | Surface | Temperature of |
|---|---|---|---|---|---|---|---|---|
| Assembly Type of the | Test | | | Real | | Resistor | Temperature | the Diffusion |
| Heating Resistor | Voltage | Current | | Power | | ValueΩ | ° C. | Staff ° C. |
| a Resistor with a | 120 VAC | 18.52 | mA | 2.2 | W | 6.5K | 97.5 | 89.6 |
| 130° C. External | | | | | | | | |
| Contact Thermal | | | | | | | | |
| Fuse is Encapsulated | | | | | | | | |
| by a Ceramic Housing | | | | | | | | |
| a Resistor with a | 120 VAC | 18.51 | mA | 2.2 | W | 6.5K | 94.3 | 88.2 |
| 130° C. External | | | | | | | | |
| Contact Thermal | | | | | | | | |
| Fuse is Encapsulated | | | | | | | | |
| by a Ceramic Housing | | | | | | | | |
| a Resistor with a | 120 VAC | 18.55 | mA | 2.2 | W | 6.5K | 95.6 | 87.9 |
| 130° C. External | | | | | | | | |
| Contact Thermal | | | | | | | | |
| Fuse is Encapsulated | | | | | | | | |
| by a Ceramic Housing | | | | | | | | |
| a Resistor with a | 120 VAC | 18.52 | mA | 2.2 | W | 6.5K | 96.8 | 86.5 |
| 130° C. External | | | | | | | | |
| Contact Thermal | | | | | | | | |
| Fuse is Encapsulated | | | | | | | | |
| by a Ceramic Housing | | | | | | | | |
| a Resistor with a | 120 VAC | 18.53 | mA | 2.2 | W | 6.5K | 95.8 | 87.9 |
| 130° C. External | | | | | | | | |
| Contact Thermal | | | | | | | | |
| Fuse is Encapsulated | | | | | | | | |
| by a Ceramic Housing | | | | | | | | |
| a Resistor with a | 120 VAC | 10.4 | mA | 1.25 | W | 11.5K | 92 | 92 |
| Built-in Thermal Fuse | | | | | | | | |
| a Resistor with a | 120 VAC | 10.4 | mA | 1.25 | W | 11.5K | 90.8 | 90.8 |
| Built-in Thermal Fuse | | | | | | | | |
| a Resistor with a | 120 VAC | 10.4 | mA | 1.25 | W | 11.5K | 93.2 | 93.2 |
| Built-in Thermal Fuse | | | | | | | | |
| a Resistor with a | 120 VAC | 10.4 | mA | 1.25 | W | 11.5K | 92.7 | 92.7 |
| Built-in Thermal Fuse | | | | | | | | |
| a Resistor with a | 120 VAC | 10.4 | mA | 1.25 | W | 11.5K | 91.8 | 91.8 |
| Built-in Thermal Fuse | | | | | | | | |

According to above data comparison, under equal temperature of the diffusion staff, the power consumption of this embodiment is a saving of 50% power to existing technology.

### The Sixth Embodiment

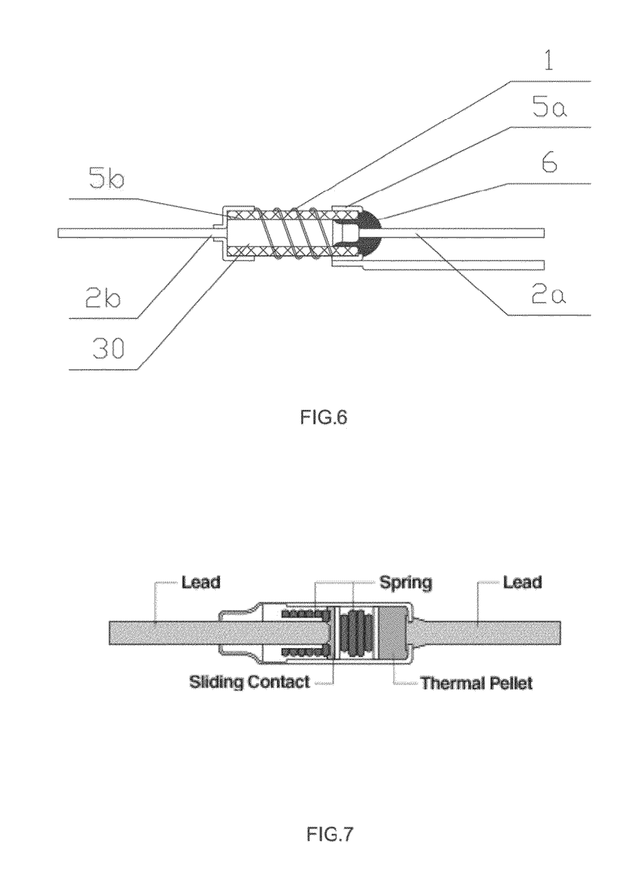

As figured in FIG. 6, thermal fuse 30 with an organism temperature sensing is disposed inside the ceramic tube 1 (the principle structure is figured in FIG. 7), two ends of the ceramic tube 1 are locked with the metal caps 5a, 5b, forming a tight integration. The centre of the metal cap 5b is extended out with a liplike edge, which is connected to the lead wire 2b of the thermal fuse 30; when the metal cap 5b is welded with the alloy wire of the wirewound resistor, the thermal fuse and the wirewound resistor are connected in series. The hole in the centre of the metal cap 5a is large enough for the lead wire 2a of the thermal fuse 30 to pass through, a clearance is formed between the hole and the lead wire 2a, the creepage distance of the lead wire 2a and the metal cap 5a increases to a safe distance after the clearance is encapsulated by epoxy resin 6. if the shape of the metal cap 5b is like the metal cap 5a, and the lead wire 2b of the thermal fuse 30 is passing through the centre, a clearance is formed between the hole and the lead wire 2b, the creepage distance of the lead wire 2b and the metal cap 5b increases to a safe distance after the clearance is encapsulated by epoxy resin 6. the resistor and the thermal fuse have no electrical connections but quick thermal transferring.

When two ends of the ceramic tube 1 of the thermal fuse are sleeved with the metal cap 5a, 5b, basic body of the wirewound resistor is shaped. Wire is wound in the resistor alloy wire 7 in the basic body, two ends of the resistor alloy wire 7 are welded to the metal cap 5a, 5b. then a lead wire 8 is welded to the metal cap 5a as the output of the wirewound resistor. The whole product is encapsulated by epoxy resin 9 finally. In this way, a wirewound resistor with a built-in thermal fuse is made out. The wirewound resistor on the external surface of the ceramic tube 1 can be changed into a carbon-film resistor, a metal-film resistor or a thick film resistor, forming a resistor against over-heat with different power.

### INDUSTRIAL APPLICABILITY

The present invention can be served as a basic unit, which is directly assembled to an existing high-frequency charger, it can take place of the existing simple wirewound resistor or the wirewound resistor with a thermal fuse external contacted, realizing triple functions of normal resistor function, melt protection function in high current, over-heat protection when overloaded.

What is claimed is:

1. A device combining a thermal fuse and a resistor, wherein the solid ceramic base of the wirewound resistor is changed to be hollow, a thermal fuse is disposed inside the ceramic base, the ceramic tube is the housing of the thermal fuse, one lead wire of the thermal fuse is passing through the end cap of one end of the wirewound resistor, the other end of the thermal fuse is extended out of the end cap of the other end of the wirewound resistor, the end cap of the wirewound resistor is extended out with a lead wire, then the whole product is encapsulated by epoxy resin.

2. A device combining a thermal fuse and a resistor according to claim 1, wherein the lead wire of the thermal fuse is passing through the end cap of one end of the wirewound resistor, making the thermal fuse is connected to the wirewound resistor in series.

3. A device combining a thermal fuse and a resistor according to claim 2, wherein a fluxing agent is disposed around the low melting alloy wire between two lead wires of the thermal fuse to improve the alloy wire to contract to two sides and cut off when molten, the thermal fuse, fluxing agent and the alloy wire form a whole under the normal temperature and place inside the ceramic tube.

4. A device combining a thermal fuse and a resistor according to claim 2, wherein the wirewound resistor with a built-in thermal fuse can be serviced as a basic unit to assemble to a high-frequency charger.

5. A device combining a thermal fuse and a resistor according to claim 2, wherein the resistor value of the wirewound resistor and the temperature value of the thermal fuse are collected to accompany with each other, making that the wirewound resistor heated to accelerate the thermal fuse to cut off, the device combining a thermal fuse and a resistor is applied in a motor with over-heat protection.

6. A device combining a thermal fuse and a resistor according to claim 2, wherein the alloy wire resistor is carbon-film resistor or metal-film resistor, the resistor value increase to thousands of ohms, forming a heating resistor with over-heat protection.

7. A device combining a thermal fuse and a resistor according to claim 1, wherein the end caps in two ends of the resistor are opened, two lead wires of the thermal fuse are passing through the openings of the end caps, two end caps of the resistor are separately disposed with a lead wire extended out and then encapsulated by epoxy resin, forming a circuit that the thermal fuse and the resistor are parallel to each other and realizing to cut off the thermal fuse heater by different circuits.

8. A device combining a thermal fuse and a resistor according to claim 1, wherein the product is encapsulated by epoxy resin and insulated or applied with silicone or inorganic material as insulation layer.

9. A device combining a thermal fuse and a resistor according to claim 1, wherein two ends of the ceramic base of the resistor are opened, or one end of the ceramic base of the resistor is opened while the other end is disposed with a hole for a lead pin to extend out.
